(19) United States
(12) Patent Application Publication
(10) Pub. No.: US 2024/0396672 A1
(43) Pub. Date: Nov. 28, 2024

(54) MAXIMUM TIME FOR DEFERRED FEEDBACK MESSAGE

(71) Applicant: QUALCOMM Incorporated, San Diego, CA (US)

(72) Inventors: Konstantinos DIMOU, New York, NY (US); Yan ZHOU, San Diego, CA (US); Kianoush HOSSEINI, San Diego, CA (US); Yi HUANG, San Diego, CA (US); Tao LUO, San Diego, CA (US)

(21) Appl. No.: 18/262,700

(22) PCT Filed: Mar. 3, 2022
(86) PCT No.: PCT/US2022/070944

§ 371 Date: Jul. 24, 2023

(30) Foreign Application Priority Data
Mar. 29, 2021 (GR) 20210100195

(51) Int. Cl. H04L 1/1829; H04L 1/1822; H04L 1/1867

(52) U.S. Cl. CPC H04L 1/1854; H04L 1/1822; H04L 1/1896

(57) ABSTRACT

Various aspects of the present disclosure generally relate to wireless communication. In some aspects, a user equipment (UE) may receive an indication of a maximum deferral time for deferring transmission of a feedback message after receiving a physical downlink control channel (PDCCH) or physical downlink shared channel (PDSCH) communication. The UE may receive the PDCCH or PDSCH communication. The UE may transmit the feedback message for the PDCCH or PDSCH communication within the maximum deferral time if the feedback message is deferred beyond a scheduled time for transmission. Numerous other aspects are described.

### CROSS-REFERENCE TO RELATED APPLICATION

This Patent application claims priority to Greek patent application No. 20210100195, filed on Mar. 29, 2021, entitled “MAXIMUM TIME FOR DEFERRED FEEDBACK MESSAGE,” which is hereby expressly incorporated by reference herein.

### FIELD OF THE DISCLOSURE

Aspects of the present disclosure generally relate to wireless communication and to techniques and apparatuses for using a maximum time for deferring a feedback message.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” or “forward link” refers to the communication link from the BS to the UE, and “uplink” or “reverse link” refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving an indication of a maximum deferral time for deferring transmission of a feedback message after receiving a physical downlink control channel (PDCCH) or physical downlink shared channel (PDSCH) communication. The method may include receiving the PDCCH or PDSCH communication and transmitting the feedback message for the PDCCH or PDSCH communication within the maximum deferral time if the feedback message is deferred beyond a scheduled time for transmission.

In some aspects, a method of wireless communication performed by a base station includes transmitting, to a UE, an indication of a maximum deferral time for deferring transmission of a feedback message after the UE receives a PDCCH or PDSCH communication from the base station. The method includes transmitting the PDCCH or PDSCH communication and receiving the feedback message that is transmitted within the maximum deferral time and after a scheduled time for transmission.

In some aspects, a UE for wireless communication includes a memory and one or more processors, coupled to the memory, configured to receive an indication of a maximum deferral time for deferring transmission of a feedback message after receiving a PDCCH or PDSCH communication, receive the PDCCH or PDSCH communication, and transmit the feedback message for the PDCCH or PDSCH communication within the maximum deferral time if the feedback message is deferred beyond a scheduled time for transmission.

In some aspects, a base station for wireless communication includes a memory and one or more processors, coupled to the memory, configured to transmit, to a UE, an indication of a maximum deferral time for deferring transmission of a feedback message after the UE receives a PDCCH or PDSCH communication from the base station, transmit the PDCCH or PDSCH communication, and receive the feedback message that is transmitted within the maximum deferral time and after a scheduled time for transmission.

In some aspects, a non-transitory computer-readable medium storing a set of instructions for wireless communication includes one or more instructions that, when executed by one or more processors of a UE, cause the UE to receive an indication of a maximum deferral time for deferring transmission of a feedback message after receiving a PDCCH or PDSCH communication, receive the PDCCH or PDSCH communication, and transmit the feedback message for the PDCCH or PDSCH communication within the maximum deferral time if the feedback message is deferred beyond a scheduled time for transmission.

In some aspects, a non-transitory computer-readable medium storing a set of instructions for wireless communication includes one or more instructions that, when executed by one or more processors of a base station, cause the base station to transmit, to a UE, an indication of a maximum deferral time for deferring transmission of a feedback message after the UE receives a PDCCH or PDSCH communication from the base station, transmit the PDCCH or PDSCH communication, and receive the feedback message that is transmitted within the maximum deferral time and after a scheduled time for transmission.

In some aspects, an apparatus for wireless communication includes means for receiving an indication of a maximum deferral time for deferring transmission of a feedback message after receiving a PDCCH or PDSCH communication, means for receiving the PDCCH or PDSCH communication, and means for transmitting the feedback message for the PDCCH or PDSCH communication within the maximum deferral time if the feedback message is deferred beyond a scheduled time for transmission.

In some aspects, an apparatus for wireless communication includes means for transmitting, to a UE, an indication of a maximum deferral time for deferring transmission of a feedback message after the UE receives a PDCCH or PDSCH communication from the base station, means for transmitting the PDCCH or PDSCH communication, and means for receiving the feedback message that is transmitted within the maximum deferral time and after a scheduled time for transmission.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, RF chains, power amplifiers, modulators, buffers, processor(s), interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a UE in a wireless network, in accordance with the present disclosure.

FIG. 3 is a diagram illustrating an example of a feedback message collision due to a slot format change, in accordance with the present disclosure.

FIG. 4 is a diagram illustrating an example of a feedback message collision due to a dedicated grant, in accordance with the present disclosure.

FIG. 5 is a diagram illustrating an example of using a maximum time for deferring a feedback message, in accordance with the present disclosure.

FIG. 6 is a diagram illustrating an example of using a maximum time for deferring a feedback message, in accordance with the present disclosure.

FIG. 7 is a diagram illustrating an example process performed, for example, by a UE, in accordance with the present disclosure.

FIG. 8 is a diagram illustrating an example process performed, for example, by a base station, in accordance with the present disclosure.

FIGS. 9-10 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

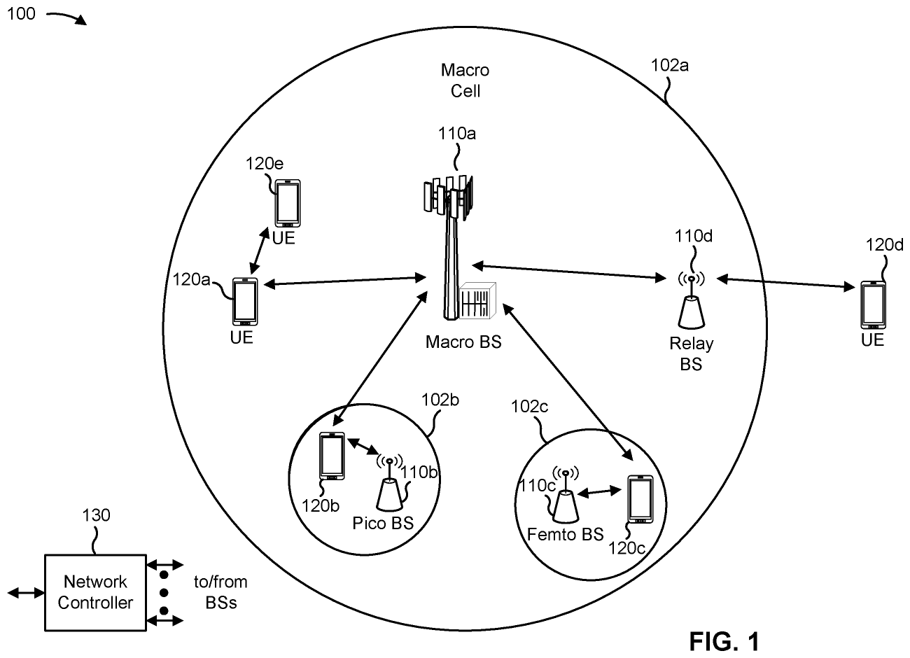

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “CNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrow band internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120c) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHZ, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHZ, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHZ, frequencies within FR1, and/or mid-band frequencies (e.g., greater than 7.125 GHZ). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHZ). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

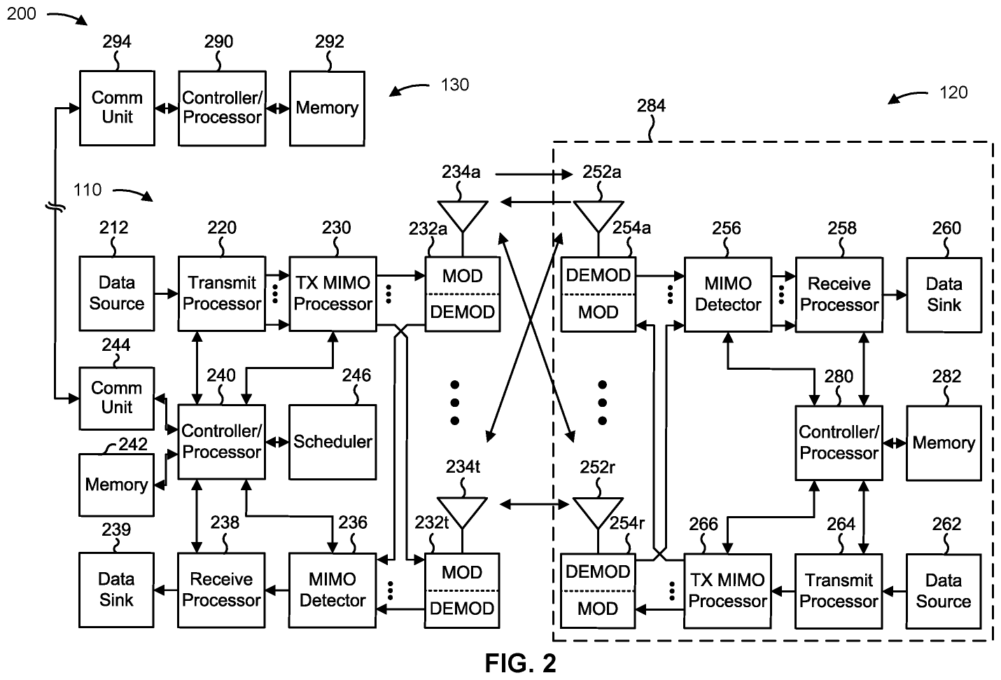

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, as described with reference to FIGS. 1-10).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, as described with reference to FIGS. 1-10).

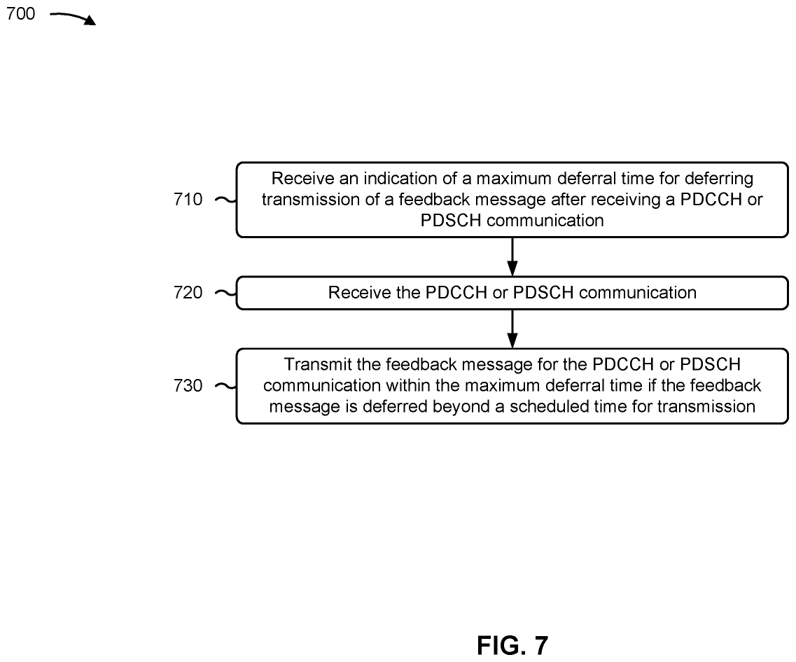

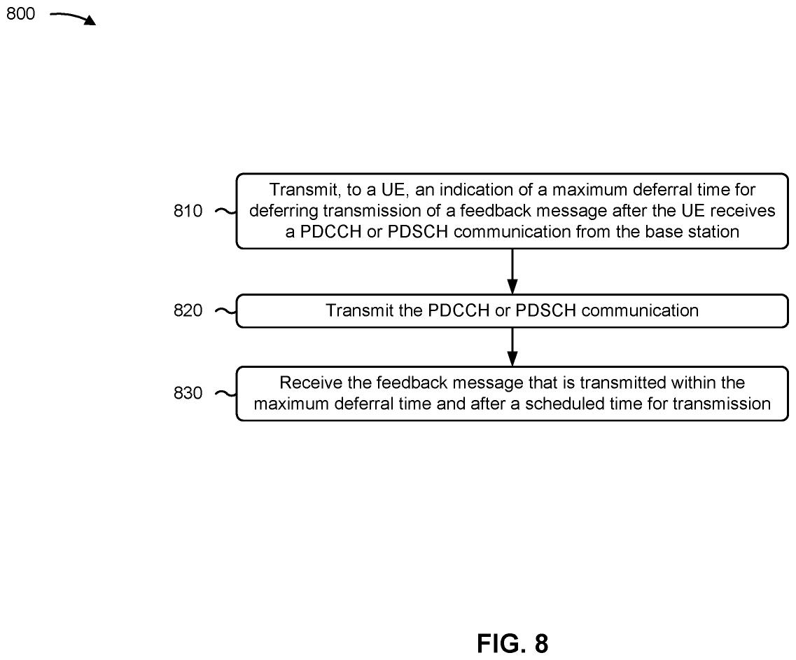

Controller/processor 240 of base station 110, controller/processor 280 of UE 120, and/or any other component(s) of FIG. 2 may perform one or more techniques associated with using a maximum time for deferring a feedback message, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 700 of FIG. 7, process 800 of FIG. 8, and/or other processes as described herein. In some aspects, executing instructions may include running the instructions, converting the instructions, compiling the instructions, and/or interpreting the instructions, among other examples.

In some aspects, the UE 120 includes means for receiving an indication of a maximum deferral time for deferring transmission of a feedback message after receiving a physical downlink control channel (PDCCH) or physical downlink shared channel (PDSCH) communication, means for receiving the PDCCH or PDSCH communication, and/or means for transmitting the feedback message for the PDCCH or PDSCH communication within the maximum deferral time if the feedback message is deferred beyond a scheduled time for transmission. The means for the UE 120 to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the base station 110 includes means for transmitting, to a UE, an indication of a maximum deferral time for deferring transmission of a feedback message after the UE receives a PDCCH or PDSCH communication from the base station, means for transmitting the PDCCH or PDSCH communication, and/or means for receiving the feedback message that is transmitted within the maximum deferral time and after a scheduled time for transmission. The means for the base station 110 to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

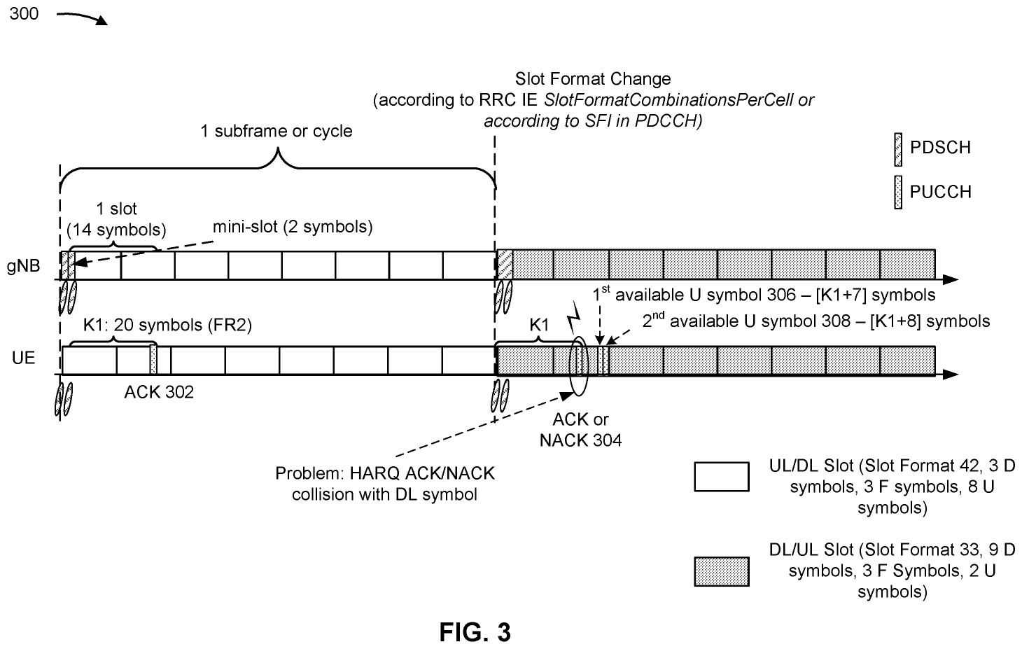

FIG. 3 is a diagram illustrating an example 300 of a feedback message collision due to a slot format change, in accordance with the present disclosure. Time-frequency resources in a radio access network may be partitioned into resource blocks (RBs), sometimes referred to as physical resource blocks (PRBs) or transport blocks. An RB may include a set of subcarriers (e.g., 12 subcarriers) and a set of symbols (e.g., 14 symbols) that are scheduled by a base station (e.g., agNB) as a unit. In some aspects, an RB may include a set of subcarriers in a single time slot. A single time-frequency resource included in a slot may be referred to as a resource element (RE). An RE may include a single subcarrier (e.g., in frequency) and a single symbol (e.g., in time). A symbol may be referred to as an OFDM symbol.

In some telecommunication systems (e.g., NR), a radio frame may include 10 subframes (or time cycles), each with a length of 1 ms. A subframe may have multiple slots, such as 8 slots (each with a length of 0.125 ms). The number of slots and slot length may vary depending on a numerology used for communications (e.g., a subcarrier spacing, a cyclic prefix format). A slot may be configured with a link direction (e.g., downlink or uplink) for transmission. In some aspects, the link direction for a slot may be dynamically configured.

A UE may transmit or receive a communication at each symbol of a time slot. Each symbol of the slot may have a communication mode, which may be an uplink communication mode (U), a downlink communication mode (D), a gap symbol (blank), or a flexible symbol (F). A combination of communication modes for a slot may be referred to as a “slot format,” which may be identified with a slot format indicator (SFI). For example, FIG. 3 shows 8 slots of a first subframe, where each slot (in slot format 42) includes 3 D symbols, 3 F symbols, and 8 U symbols. After a slot format change, caused by receiving a radio resource control (RRC) message or a new SFI in a physical downlink control channel (PDCCH), each slot in the next subframe (for slot format 33) includes 9 D symbols, 3 F symbols, and 2 U symbols. That is, there are now fewer U symbols in which the UE can transmit on a physical uplink control channel (PUCCH). This can cause a collision for a feedback message, such as an acknowledgement (ACK) or a negative acknowledgement (NACK), that is to be transmitted in a U symbol.

In the first subframe of FIG. 3, the UE may receive a communication on the PDCCH or a physical downlink shared channel (PDSCH). After a processing time (K1), the UE may transmit a feedback message (e.g., ACK 302) in an available U symbol. However, due to the slot format change for the next subframe, the UE may not be able to transmit a feedback message (e.g., ACK or NACK 304) at an expected U symbol. What was previously a U symbol in the first subframe is now a D symbol in the next subframe, and thus the feedback message, scheduled for a U symbol, collides with the D symbol. In an ultra-reliable low-latency communication (URLLC) scenario, the feedback message needs to be transmitted despite the initial collision, and the UE may defer the feedback message and attempt to transmit the feedback message in a first available U slot 306 or a second available U slot 308.

As indicated above, FIG. 3 is provided as an example. Other examples may differ from what is described with regard to FIG. 3.

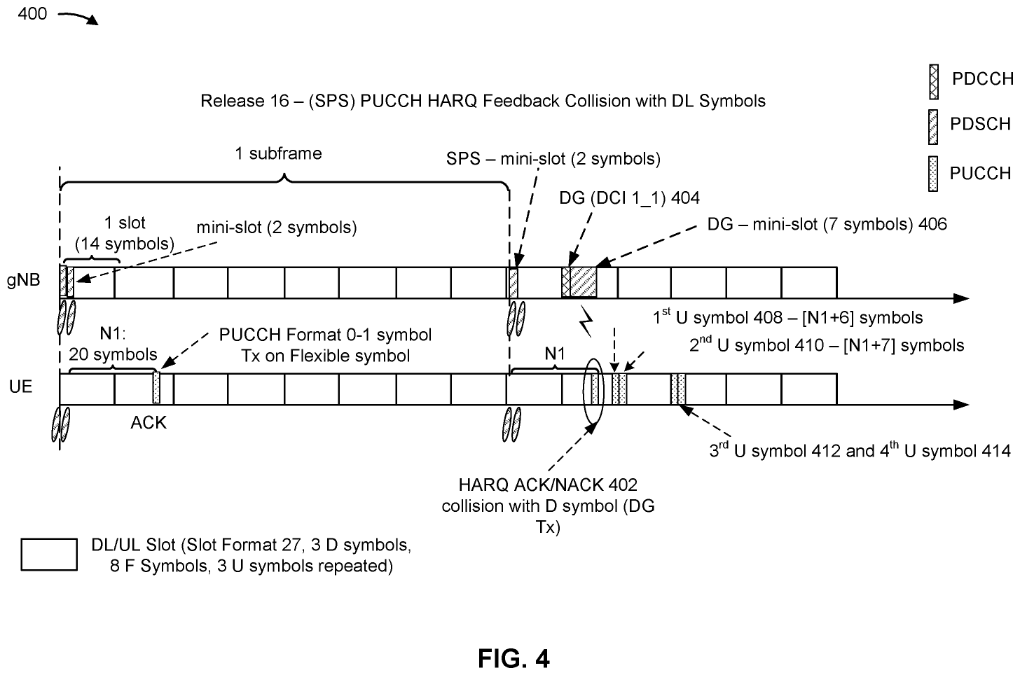

FIG. 4 is a diagram illustrating an example 400 of a feedback message collision due to a dedicated grant, in accordance with the present disclosure.

A UE in a semi-persistent scheduling (SPS) scheme may be scheduled to transmit a feedback message (e.g., hybrid automatic repeat request (HARQ) ACK/NACK 402) at a U symbol after a processing time (N1). However, the UE may receive a dynamic grant (DG) 404 that schedules a mini-slot 406 of 7 symbols on the PDSCH that now overlaps the U symbol in which the UE was to transmit the feedback message. After this collision caused by the dynamic grant switching the U symbol to a D symbol, the UE may defer the feedback message and attempt to transmit the feedback message in a later U symbol, such as at U symbols 408, 410, 412, or 414.

In some scenarios, the first U symbol 408 may be overloaded, and the UE may defer the feedback message to U symbols 410, 412, or 414. However, if U symbols 410, 412, and 414 are not available, the UE may continue to defer the feedback message. Deferring the feedback message beyond U symbol 414 may compound scheduling issues or collisions for later feedback messages and uplink transmissions, which may also be deferred. This may cause the UE to waste processing resources and signaling resources.

As indicated above, FIG. 4 is provided as an example. Other examples may differ from what is described with regard to FIG. 4.

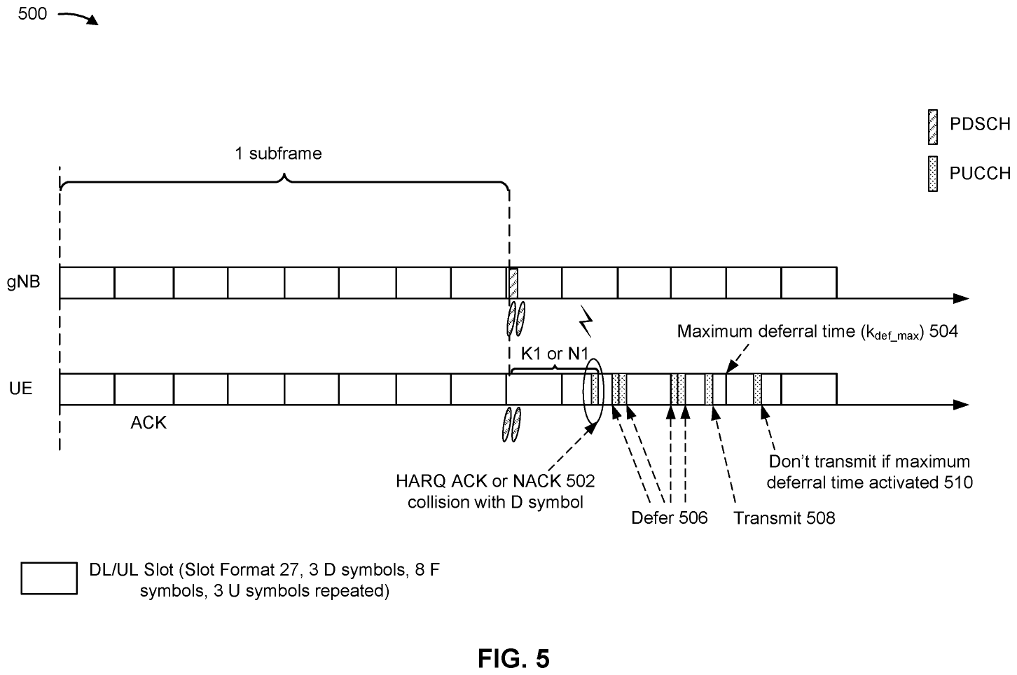

FIG. 5 is a diagram illustrating an example 500 of using a maximum time for deferring a feedback message, in accordance with the present disclosure.

According to various aspects described herein, a base station may configure a with a maximum deferral time by which the UE may attempt to transmit a feedback message. The maximum deferral time may be defined by a time duration, such as milliseconds (ms) or microseconds, or defined by slots, sub-slots, or symbols. The maximum deferral time may be configured per SPS configuration (e.g., 1 ms for SPS 1, 4 ms for SPS 2), per PUCCH group, per HARQ process identifier (ID), or per transport block. In this way, the UE may not defer the feedback message beyond what is practical. For example, a packet may have a packet expiration time. It may not be practical to continue to defer the feedback message past the packet expiration time. URLLC packets may expire after the patent expiration time (t_{expiry}) and any feedback message after the patent expiration time may be useless. Accordingly, the maximum deferral time may be limited by the packet expiration time. The maximum deferral time may also be based at least in part on available resources, traffic conditions, a slot format, and/or other uplink transmissions that are regularly scheduled. As a result of limiting a time for deferring a feedback message, uplink transmission deferrals may not accumulate, and the UE may conserve processing resources and signaling resources.

Example 500 shows a collision for a feedback message (e.g., HARQ ACK 502). However, rather than defer the feedback message too long and cause later scheduling resource issues, the UE may be configured with a maximum deferral time (k_{def_max}) 504. As shown by reference number 506, the UE may defer the feedback message beyond some U symbols, but transmit the feedback message in an uplink message before the maximum deferral time 504, as shown by reference number 508. If the feedback message is not able to be transmitted by the maximum deferral time 504, the UE may no longer attempt transmit the feedback message, as shown by reference number 510.

As indicated above, FIG. 5 is provided as an example. Other examples may differ from what is described with regard to FIG. 5.

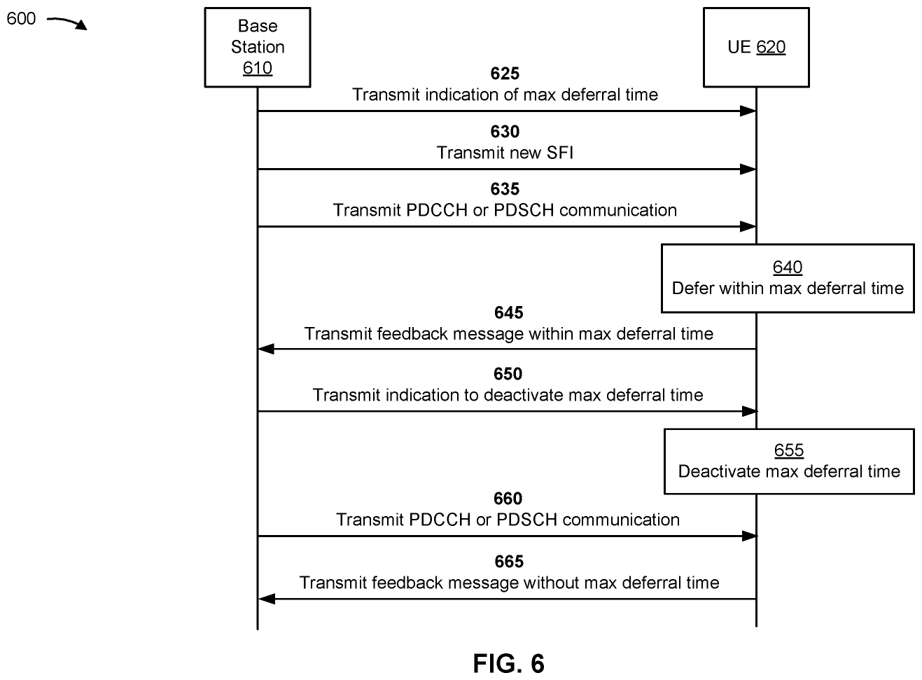

FIG. 6 is a diagram illustrating an example 600 of using a maximum time for deferring a feedback message, in accordance with the present disclosure. As shown in FIG. 6, a base station 610 (e.g., base station 110) may communicate (e.g., transmit an uplink transmission and/or receive a downlink transmission) with a UE 620 (e.g., UE 120). The UE and the base station may be part of a wireless network (e.g., wireless network 100).

As shown by reference number 625, the base station 610 may transmit an indication of a maximum deferral time. The maximum deferral time may be defined in slots or sub-slots. The base station 610 may transmit the indication in an RRC message.

As shown by reference number 630, the base station 610 may transmit a new SFI to the UE 620, which may reduce a number of U symbols or cause a collision in a symbol that was scheduled for a feedback message. As shown by reference number 635, the base station 610 may transmit a PDCCH communication or a PDSCH communication to the UE 620. The UE 620 may generate a feedback message for transmission to the base station 610 and determine that the feedback message is to be deferred from an originally scheduled symbol. As shown by reference number 640, the UE 620 may defer the feedback message while monitoring the deferral with respect to the maximum deferral time. The UE 620 may determine that a U symbol is available within the maximum deferral time. As shown by reference number 645, the UE 620 may transmit the feedback message in the UE symbol that is available within the maximum deferral time. Alternatively, if a U symbol is not available within the maximum deferral time, the UE may not transmit the feedback message and the packet will expire.

In some aspects, the maximum deferral time may be deactivated. As shown by reference number 650, the base station 610 may transmit an indication to deactivate the maximum deferral time. URLLC communications have a very low block error rate (BLER), and the base station 610 may deactivate the maximum deferral time if it is necessary to attempt to maintain the BLER for communications. The base station 610 may transmit the indication for deactivation in an RRC message, a medium access control control element (MAC-CE), or downlink control information (DCI). In some aspects, the base station 610 may deactivate the maximum deferral time by setting the maximum deferral time to a number above a threshold number or to infinity. As shown by reference number 655, the UE 620 may deactivate the maximum referral time. Therefore, if the base station transmits another PDCCH or PDSCH communication, as shown by reference number 660, the UE 620 may not abide by the maximum deferral time and may transmit a feedback message without being limited by the maximum deferral time, as shown by reference number 665. Alternatively, the UE 620 may deactivate the maximum referral time. For example, if the UE 620 just transmitted a NACK, the UE 620 may deactivate the maximum referral time to maintain a BLER.

In some aspects, the base station 610 may transmit an indication, via an RRC message, a MAC-CE, or DCI, for an update of the maximum deferral time. The UE 620 may transmit a next feedback message within the updated maximum deferral time if the next feedback message is to be deferred beyond a scheduled time for transmission. For example, if there is a high traffic load, the base station 610 may quickly indicate, via DCI, a shorter maximum deferral time such that the UE 620 only attempts to transmit the feedback message in a first available U symbol or defers the feedback message past only one more available U symbol.

As indicated above, FIG. 6 is provided as an example. Other examples may differ from what is described with regard to FIG. 6.

FIG. 7 is a diagram illustrating an example process 700 performed, for example, by a UE, in accordance with the present disclosure. Example process 700 is an example where the UE (e.g., UE 120, the UE in FIGS. 3-5, UE 620 depicted in FIG. 6) performs operations associated with using a maximum time for deferring a feedback message.

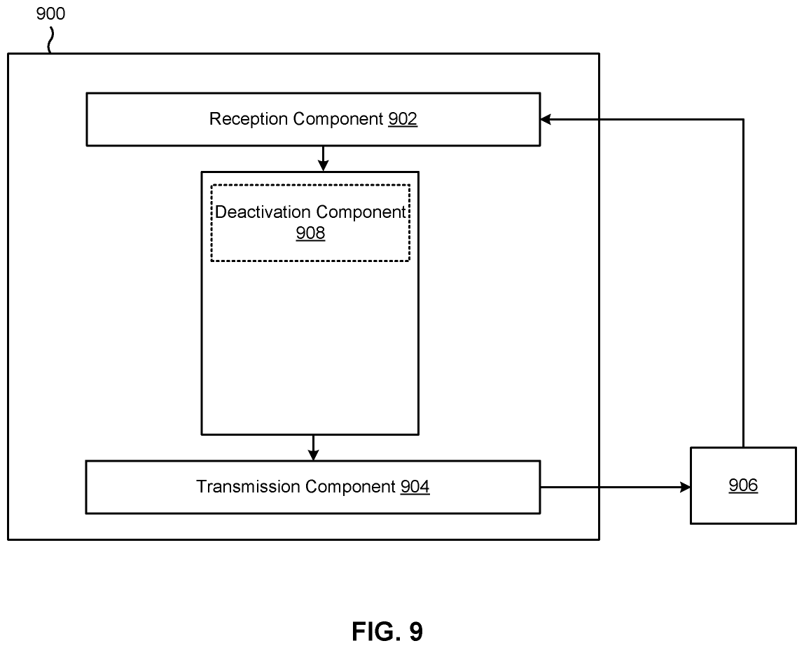

As shown in FIG. 7, in some aspects, process 700 may include receiving an indication of a maximum deferral time for deferring transmission of a feedback message after receiving a PDCCH or PDSCH communication (block 710). For example, the UE (e.g., using reception component 902 depicted in FIG. 9) may receive an indication of a maximum deferral time for deferring transmission of a feedback message after receiving a PDCCH or PDSCH communication, as described above.

As further shown in FIG. 7, in some aspects, process 700 may include receiving the PDCCH or PDSCH communication (block 720). For example, the UE (e.g., using reception component 902 depicted in FIG. 9) may receive the PDCCH or PDSCH communication, as described above.

As further shown in FIG. 7, in some aspects, process 700 may include transmitting the feedback message for the PDCCH or PDSCH communication within the maximum deferral time if the feedback message is deferred beyond a scheduled time for transmission (block 730). For example, the UE (e.g., using transmission component 904 depicted in FIG. 9) may transmit the feedback message for the PDCCH or PDSCH communication within the maximum deferral time if the feedback message is deferred beyond a scheduled time for transmission, as described above.

Process 700 may include additional aspects, such as any single aspect or any combination of aspects described below and/or in connection with one or more other processes described elsewhere herein.

In a first aspect, the indication of the maximum deferral time is defined in slots or sub-slots.

In a second aspect, alone or in combination with the first aspect, the maximum deferral time is limited by a packet expiration time.

In a third aspect, alone or in combination with one or more of the first and second aspects, the maximum deferral time is deactivated after a packet expiration time.

In a fourth aspect, alone or in combination with one or more of the first through third aspects, the maximum deferral time is deactivated after the UE transmits a NACK as the feedback message.

In a fifth aspect, alone or in combination with one or more of the first through fourth aspects, the maximum deferral time is configured per SPS configuration.

In a sixth aspect, alone or in combination with one or more of the first through fifth aspects, the maximum deferral time is configured per PUCCH group.

In a seventh aspect, alone or in combination with one or more of the first through sixth aspects, the maximum deferral time is configured per HARQ process ID.

In an eighth aspect, alone or in combination with one or more of the first through seventh aspects, the maximum deferral time is configured per transport block.

In a ninth aspect, alone or in combination with one or more of the first through eighth aspects, the indication is received in an RRC message.

In a tenth aspect, alone or in combination with one or more of the first through ninth aspects, process 700 includes receiving an updated maximum deferral time via an RRC message, a MAC-CE, or DCI, and transmitting a next feedback message for a next PDCCH or PDSCH communication within the updated maximum deferral time if the next feedback message is deferred beyond a scheduled time for transmission.

In an eleventh aspect, alone or in combination with one or more of the first through tenth aspects, process 700 includes receiving an indication to deactivate the maximum deferral time, and deactivating the maximum deferral time.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with the present disclosure. Example process 800 is an example where the base station (e.g., base station 110) performs operations associated with using a maximum time for deferring a feedback message.

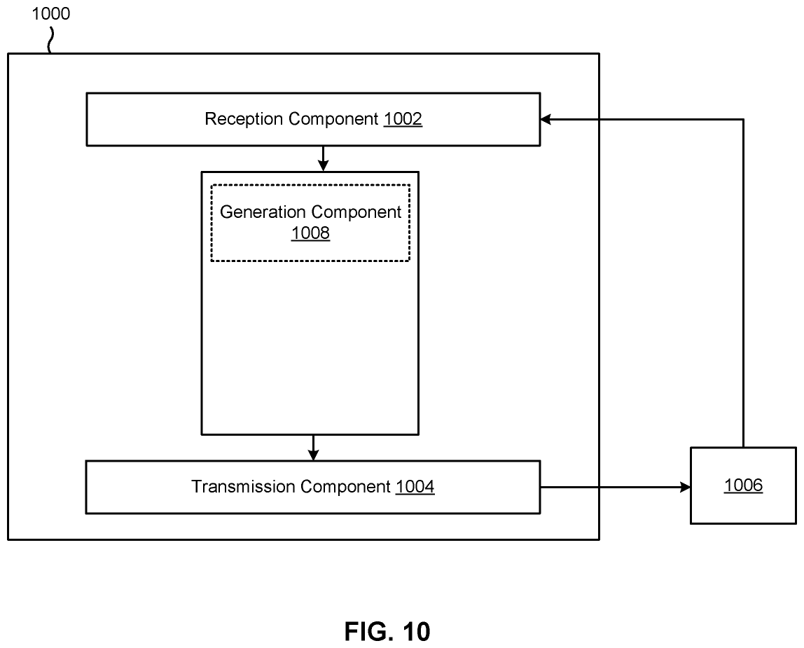

As shown in FIG. 8, in some aspects, process 800 may include transmitting, to a UE, an indication of a maximum deferral time for deferring transmission of a feedback message after the UE receives a PDCCH or PDSCH communication from the base station (block 810). For example, the base station (e.g., using transmission component 1004 depicted in FIG. 10) may transmit, to a UE, an indication of a maximum deferral time for deferring transmission of a feedback message after the UE receives a PDCCH or PDSCH communication from the base station, as described above.

As further shown in FIG. 8, in some aspects, process 800 may include transmitting the PDCCH or PDSCH communication (block 820). For example, the base station (e.g., using transmission component 1004 depicted in FIG. 10) may transmit the PDCCH or PDSCH communication, as described above.

As further shown in FIG. 8, in some aspects, process 800 may include receiving the feedback message that is transmitted within the maximum deferral time and after a scheduled time for transmission (block 830). For example, the base station (e.g., using reception component 1002 depicted in FIG. 10) may receive the feedback message that is transmitted within the maximum deferral time and after a scheduled time for transmission, as described above.

Process 800 may include additional aspects, such as any single aspect or any combination of aspects described below and/or in connection with one or more other processes described elsewhere herein.

In a first aspect, the indication of the maximum deferral time is defined in slots or sub-slots.

In a second aspect, alone or in combination with the first aspect, the maximum deferral time is limited by a packet expiration time.

In a third aspect, alone or in combination with one or more of the first and second aspects, process 800 includes transmitting an indication to deactivate the maximum deferral time.

In a fourth aspect, alone or in combination with one or more of the first through third aspects, the maximum deferral time is configured per semi-persistent scheduling configuration.

In a fifth aspect, alone or in combination with one or more of the first through fourth aspects, the maximum deferral time is configured per PUCCH group.

In a sixth aspect, alone or in combination with one or more of the first through fifth aspects, the maximum deferral time is configured per HARQ process ID.

In a seventh aspect, alone or in combination with one or more of the first through sixth aspects, the maximum deferral time is configured per transport block.

In an eighth aspect, alone or in combination with one or more of the first through seventh aspects, the indication is transmitted in an RRC message.

In a ninth aspect, alone or in combination with one or more of the first through eighth aspects, process 800 includes transmitting an updated maximum deferral time via an RRC message, a MAC-CE, or DCI, and receiving a next feedback message for a next PDCCH or PDSCH communication, where the next feedback message is transmitted within the updated maximum deferral time and after a scheduled time for transmission.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a block diagram of an example apparatus 900 for wireless communication. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a deactivation component 908, among other examples.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described above in connection with FIG. 2. Additionally, or alternatively, one or more components shown in FIG. 9 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 906. In some aspects, the reception component 902 may include one or more antennas, a demodulator, a MIMO detector, a receive processor, a controller/processor, a memory, or a combination thereof, of the UE described above in connection with FIG. 2.

The transmission component 904 may transmit communications, such as reference signals, control information, data communications, or a combination thereof, to the apparatus 906. In some aspects, one or more other components of the apparatus 906 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modulator, a transmit MIMO processor, a transmit processor, a controller/processor, a memory, or a combination thereof, of the UE described above in connection with FIG. 2. In some aspects, the transmission component 904 may be co-located with the reception component 902 in a transceiver.

The reception component 902 may receive an indication of a maximum deferral time for deferring transmission of a feedback message after receiving a PDCCH or PDSCH communication. The reception component 902 may receive the PDCCH or PDSCH communication. The transmission component 904 may transmit the feedback message for the PDCCH or PDSCH communication within the maximum deferral time if the feedback message is deferred beyond a scheduled time for transmission.

The reception component 902 may receive an updated maximum deferral time via an RRC message, a MAC-CE, or DCI.

The transmission component 904 may transmit a next feedback message for a next PDCCH or PDSCH communication within the updated maximum deferral time if the next feedback message is deferred beyond a scheduled time for transmission.

The reception component 902 may receive an indication to deactivate the maximum deferral time. The deactivation component 908 may deactivate the maximum deferral time.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a block diagram of an example apparatus 1000 for wireless communication. The apparatus 1000 may be a base station, or a base station may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a generation component 1008, among other examples.

In some aspects, the apparatus 1000 may be configured to perform one or more operations described herein in connection with FIGS. 1-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the base station described above in connection with FIG. 2. Additionally, or alternatively, one or more components shown in FIG. 10 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1006. In some aspects, the reception component 1002 may include one or more antennas, a demodulator, a MIMO detector, a receive processor, a controller/processor, a memory, or a combination thereof, of the base station described above in connection with FIG. 2.

The transmission component 1004 may transmit communications, such as reference signals, control information, data communications, or a combination thereof, to the apparatus 1006. In some aspects, one or more other components of the apparatus 1006 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modulator, a transmit MIMO processor, a transmit processor, a controller/processor, a memory, or a combination thereof, of the base station described above in connection with FIG. 2. In some aspects, the transmission component 1004 may be co-located with the reception component 1002 in a transceiver.

The transmission component 1004 may transmit, to a UE, an indication of a maximum deferral time for deferring transmission of a feedback message after the UE receives a PDCCH or PDSCH communication from the base station. The transmission component 1004 may transmit the PDCCH or PDSCH communication. The reception component 1002 may receive the feedback message that is transmitted within the maximum deferral time and after a scheduled time for transmission.

The generation component 1008 may generate a maximum deferral time based at least in part on a UE capability, a UE configuration, a numerology, and/or traffic conditions. The transmission component 1004 may transmit an indication to deactivate the maximum deferral time. The transmission component 1004 may transmit an updated maximum deferral time via an RRC message, a MAC-CE, or DCI.

The reception component 1002 may receive a next feedback message for a next PDCCH or PDSCH communication, wherein the next feedback message is transmitted within the updated maximum deferral time and after a scheduled time for transmission.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The foregoing disclosure provides illustration and description, but is not intended to be exhaustive or to limit the aspects to the precise forms disclosed. Modifications and variations may be made in light of the above disclosure or may be acquired from practice of the aspects.

The following provides an overview of some Aspects of the present disclosure:

Aspect 1: A method of wireless communication performed by a user equipment (UE), comprising: receiving an indication of a maximum deferral time for deferring transmission of a feedback message after receiving a physical downlink control channel (PDCCH) or physical downlink shared channel (PDSCH) communication: receiving the PDCCH or PDSCH communication; and transmitting the feedback message for the PDCCH or PDSCH communication within the maximum deferral time if the feedback message is deferred beyond a scheduled time for transmission.

Aspect 2: The method of Aspect 1, wherein the indication of the maximum deferral time is defined in slots or sub-slots.

Aspect 3: The method of Aspect 1 or 2, wherein the maximum deferral time is limited by a packet expiration time.

Aspect 4: The method of any of Aspects 1-3, wherein the maximum deferral time is deactivated after a packet expiration time.

Aspect 5: The method of any of Aspects 1-4, wherein the maximum deferral time is deactivated after the UE transmits a negative acknowledgment as the feedback message.

Aspect 6: The method of any of Aspects 1-5, wherein the maximum deferral time is configured per semi-persistent scheduling configuration.

Aspect 7: The method of any of Aspects 1-6, wherein the maximum deferral time is configured per physical uplink control channel group.

Aspect 8: The method of any of Aspects 1-7, wherein the maximum deferral time is configured per hybrid automatic repeat request process identifier.

Aspect 9: The method of any of Aspects 1-8, wherein the maximum deferral time is configured per transport block.

Aspect 10: The method of any of Aspects 1-9, wherein the indication is received in a radio resource control message.

Aspect 11: The method of any of Aspects 1-10, further comprising: receiving an updated maximum deferral time via a radio resource control message, a medium access control control element (MAC-CE), or downlink control information; and transmitting a next feedback message for a next PDCCH or PDSCH communication within the updated maximum deferral time if the next feedback message is deferred beyond a scheduled time for transmission.

Aspect 12: The method of any of Aspects 1-11, further comprising: receiving an indication to deactivate the maximum deferral time; and deactivating the maximum deferral time.

Aspect 13: A method of wireless communication performed by a base station, comprising: transmitting, to a user equipment (UE), an indication of a maximum deferral time for deferring transmission of a feedback message after the UE receives a physical downlink control channel (PDCCH) communication from the base station: transmitting the PDCCH or PDSCH communication; and receiving the feedback message that is transmitted within the maximum deferral time and after a scheduled time for transmission.

Aspect 14: The method of Aspect 13, wherein the indication of the maximum deferral time is defined in slots or sub-slots.

Aspect 15: The method of Aspect 13 or 14, wherein the maximum deferral time is limited by a packet expiration time.

Aspect 16: The method of any of Aspects 13-15, further comprising transmitting an indication to deactivate the maximum deferral time.

Aspect 17: The method of any of Aspects 13-16, wherein the maximum deferral time is configured per semi-persistent scheduling configuration.

Aspect 18: The method of any of Aspects 13-17, wherein the maximum deferral time is configured per physical uplink control channel group.

Aspect 19: The method of any of Aspects 13-18, wherein the maximum deferral time is configured per hybrid automatic repeat request process identifier.

Aspect 20: The method of any of Aspects 13-19, wherein the maximum deferral time is configured per transport block.

Aspect 21: The method of any of Aspects 13-20, wherein the indication is transmitted in a radio resource control message.

Aspect 22: The method of any of Aspects 13-21, further comprising: transmitting an updated maximum deferral time via a radio resource control message, a medium access control control element (MAC-CE), or downlink control information; and receiving a next feedback message for a next PDCCH or PDSCH communication, wherein the next feedback message is transmitted within the updated maximum deferral time and after a scheduled time for transmission.

Aspect 23: An apparatus for wireless communication at a device, comprising a processor: memory coupled with the processor; and instructions stored in the memory and executable by the processor to cause the apparatus to perform the method of one or more of Aspects 1-22.

Aspect 24: A device for wireless communication, comprising a memory and one or more processors coupled to the memory, the memory and the one or more processors configured to perform the method of one or more of Aspects 1-22.

Aspect 25: An apparatus for wireless communication, comprising at least one means for performing the method of one or more of Aspects 1-22.

Aspect 26: A non-transitory computer-readable medium storing code for wireless communication, the code comprising instructions executable by a processor to perform the method of one or more of Aspects 1-22.

Aspect 27: A non-transitory computer-readable medium storing a set of instructions for wireless communication, the set of instructions comprising one or more instructions that, when executed by one or more processors of a device, cause the device to perform the method of one or more of Aspects 1-22.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having.” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
receiving an indication of a maximum deferral time for deferring transmission of a feedback message after receiving a physical downlink control channel (PDCCH) or physical downlink shared channel (PDSCH) communication;
receiving the PDCCH or PDSCH communication; and
transmitting the feedback message for the PDCCH or PDSCH communication within the maximum deferral time if the feedback message is deferred beyond a scheduled time for transmission.

2. The method of claim 1, wherein the indication of the maximum deferral time is defined in slots or sub-slots.

3. The method of claim 1, wherein the maximum deferral time is limited by a packet expiration time.

4. The method of claim 1, wherein the maximum deferral time is deactivated after a packet expiration time.

5. The method of claim 1, wherein the maximum deferral time is deactivated after the UE transmits a negative acknowledgment as the feedback message.

6. The method of claim 1, wherein the maximum deferral time is configured per semi-persistent scheduling configuration.

7. The method of claim 1, wherein the maximum deferral time is configured per physical uplink control channel group.

8. The method of claim 1, wherein the maximum deferral time is configured per hybrid automatic repeat request process identifier.

9. The method of claim 1, wherein the maximum deferral time is configured per transport block.

10. The method of claim 1, wherein the indication is received in a radio resource control message.

11. The method of claim 1, further comprising:
receiving an updated maximum deferral time via a radio resource control message, a medium access control control element (MAC-CE), or downlink control information; and
transmitting a next feedback message for a next PDCCH or PDSCH communication within the updated maximum deferral time if the next feedback message is deferred beyond a scheduled time for transmission.

12. The method of claim 1, further comprising:
receiving an indication to deactivate the maximum deferral time; and
deactivating the maximum deferral time.

13. A method of wireless communication performed by a base station, comprising:
transmitting, to a user equipment (UE), an indication of a maximum deferral time for deferring transmission of a feedback message after the UE receives a physical downlink control channel (PDCCH) or physical downlink shared channel (PDSCH) communication from the base station;
transmitting the PDCCH or PDSCH communication; and
receiving the feedback message that is transmitted within the maximum deferral time and after a scheduled time for transmission.

14. The method of claim 13, wherein the indication of the maximum deferral time is defined in slots or sub-slots.

15. The method of claim 13, wherein the maximum deferral time is limited by a packet expiration time.

16. The method of claim 13, further comprising transmitting an indication to deactivate the maximum deferral time.

17. The method of claim 13, wherein the maximum deferral time is configured per semi-persistent scheduling configuration.

18. The method of claim 13, wherein the maximum deferral time is configured per physical uplink control channel group.

19. The method of claim 13, wherein the maximum deferral time is configured per hybrid automatic repeat request process identifier.

20. The method of claim 13, wherein the maximum deferral time is configured per transport block.

21. The method of claim 13, wherein the indication is transmitted in a radio resource control message.

22. The method of claim 13, further comprising:
transmitting an updated maximum deferral time via a radio resource control message, a medium access control control element (MAC-CE), or downlink control information; and
receiving a next feedback message for a next PDCCH or PDSCH communication, wherein the next feedback message is transmitted within the updated maximum deferral time and after a scheduled time for transmission.

23. A user equipment (UE) for wireless communication, comprising:
a memory; and
one or more processors, coupled to the memory, configured to:
receive an indication of a maximum deferral time for deferring transmission of a feedback message after receiving a physical downlink control channel (PDCCH) or physical downlink shared channel (PDSCH) communication;
receive the PDCCH or PDSCH communication; and
transmit the feedback message for the PDCCH or PDSCH communication within the maximum deferral time if the feedback message is deferred beyond a scheduled time for transmission.

24. The UE of claim 23, wherein the maximum deferral time is limited by a packet expiration time.

25. The UE of claim 23, wherein the maximum deferral time is deactivated after a packet expiration time.

26. The UE of claim 23, wherein the maximum deferral time is deactivated after the UE transmits a negative acknowledgment as the feedback message.

27. The UE of claim 23, wherein the one or more processors are configured to:
receive an updated maximum deferral time via a radio resource control message, a medium access control control element (MAC-CE), or downlink control information; and
transmit a next feedback message for a next PDCCH or PDSCH communication within the updated maximum deferral time if the next feedback message is deferred beyond a scheduled time for transmission.

28. A base station for wireless communication, comprising:
a memory; and
one or more processors, coupled to the memory, configured to:
transmit, to a user equipment (UE), an indication of a maximum deferral time for deferring transmission of a feedback message after the UE receives a physical downlink control channel (PDCCH) or physical downlink shared channel (PDSCH) communication from the base station;
transmit the PDCCH or PDSCH communication; and
receive the feedback message that is transmitted within the maximum deferral time and after a scheduled time for transmission.

29. The base station of claim 28, wherein the one or more processors are configured to transmit an indication to deactivate the maximum deferral time.

30. The base station of claim 28, wherein the one or more processors are configured to:
transmit an updated maximum deferral time via a radio resource control message, a medium access control control element (MAC-CE), or downlink control information; and
receive a next feedback message for a next PDCCH or PDSCH communication, wherein the next feedback message is transmitted within the updated maximum deferral time and after a scheduled time for transmission.
